(19) United States
(12) Patent Application Publication
(10) Pub. No.: US 2019/0014918 A1
(43) Pub. Date: Jan. 17, 2019

(54) LIQUID BARRIER FURNITURE PROTECTOR WITH WELDED QUILTING

(71) Applicant: GREEN POINT DECOR, LLC, Mount Kisco, NY (US)

(72) Inventor: Evan Markowitz, Brooklyn, NY (US)

(21) Appl. No.: 15/650,467

(22) Filed: Jul. 14, 2017

(51) Int. Cl. A47C 31/11; A47G 11/00; B32B 37/00; B32B 37/06; B32B 5/02; B32B 27/40; B32B 27/08; B32B 27/12

(52) U.S. Cl. CPC A47C 31/113; A47G 11/003; B32B 37/0084; B32B 37/06; B32B 5/022; B32B 2479/00; B32B 27/08; B32B 27/12; B32B 2262/062; B32B 2307/7265; B32B 27/40

(57) ABSTRACT

Disclosed herein is a liquid barrier protective cover used to protect the outer surface of a furniture article. The liquid barrier protective cover includes a first layer formed of a protective material, a second layer formed of a liquid barrier material, and an intermediate layer, which are all fused together at one or more discrete locations. The cover also includes a retention tie connected to at least one of the first layer or the second layer. The retention tie is operable to extend around a first portion of the furniture article such that the retention tie operably anchors the first layer and the second layer to the furniture article. The retention tie is attached to at least one of the first layer or the second layer such that the liquid barrier material of the second layer is held against the first portion of the furniture article.

### TECHNICAL FIELD

Disclosed herein are furniture protectors and, more particularly, furniture protectors having multiple layers including a waterproof layer.

### BACKGROUND

Typical furniture articles including couches, chairs, or the like encounter high usage, causing wear and tear. These furniture articles benefit from the use of surface protection to extend their lives by reducing the wear and tear directly to the furniture themselves. In addition, most of these furniture articles are further benefited by the use of a movement reduction element that helps hold the surface protection in place so that the maximum benefit from the surface protection can be achieved.

Numerous different forms of waterproofing elements are used in the furniture protective cover industry. Many solutions use quilting that penetrates the waterproof layer. After a single washing/drying cycle of the cover the waterproof characteristic of the cover fails. The agitation of the washing/drying process increases the size of the holes through the waterproof layer, which subsequently allows water to permeate the layers when in use. Some solutions avoid connecting the waterproofing elements to the top layer along the interior causing excessive slippage between the two layers. Additionally, the materials are sometimes topically treated with a waterproofing agent. Again, the washing/drying cycle of the cover reduces or eliminates the effectiveness of the topical treatment. The layers are also not connected in these situations, which again leads to slippage between the layers.

A suitable solution to overcome liquid problems in the furniture protective cover industry has not been provided. Specifically, a light-weight protective cover with a liquid barrier material and/or retention straps that allows the cover to drape in an aesthetic manner over a furniture article. It is desirable that the solution does not significantly alter the flexibility or usability of the protective cover while at the same time it securely retains the cover on the furniture article.

### SUMMARY

According to the present disclosure there is provided furniture protectors having retention straps for securing the protector to the furniture.

In accordance with various embodiments, a liquid barrier protective cover includes a first layer formed of a protective material having a peripheral region surrounding an interior portion. The liquid barrier protective cover also includes a second layer formed of a liquid barrier material having a peripheral region surrounding an interior portion. The liquid barrier protective cover also includes a third layer positioned between the first layer and the second layer, wherein the first layer, the second layer, and the third layer are fused at a plurality of locations defining a quilted connection.

In some embodiments, the liquid barrier protective cover also includes a fourth layer which is also fused to the first layer, second layer, and third layer. The first layer may be a microfiber and the second layer a polyurethane material. The third layer may be a fiber-fill material. The fourth layer may be a non-woven backing material. The second layer may be laminated to the fourth layer and the first layer is laminated to the third layer. Each of the plurality of fused locations may be spaced from one another in which the first layer and the second layer are unattached to each other. At least some of the plurality of fused locations may form a plurality of lines making a quilted pattern. The quilted pattern may be arranged in intervals extending across a portion of the interior portion of the liquid barrier material and the protective material. The quilted pattern traverses the interior portion may from a first portion of the peripheral region to a second portion of the peripheral region. The quilted pattern traverses the interior portion having the plurality of lines extending in two different directions.

In various embodiments a method of manufacturing the liquid barrier protective cover discussed above may include forming each of the fuses between the first layer, the second layer, and the third layer by applying high frequency sound waves between the first layer, the second layer, and the third layer. The method may also include applying pressure between the first layer, the second layer, and the third layer during the application of the high frequency sound waves. The pressure may be applied between the first layer, the second layer, and the third layer via opposing rollers. Heat may also be applied to the first layer, the second layer, and the third layer via opposing rollers. The interior portions of the first layer, the second layer and the third layer may be connected without puncturing any of the layers.

### BRIEF DESCRIPTION OF THE DRAWINGS

The description will be more fully understood with reference to the following figures, which are presented as various embodiments of the disclosure and should not be construed as a complete recitation of the scope of the disclosure, characterized in that:

FIG. 1A is a front perspective view of a furniture article with protective cover thereon in accordance with various embodiments;

FIG. 1B is a rear perspective view of a furniture article with protective cover thereon in accordance with various embodiments;

FIG. 1C is a front perspective view of a furniture article showing retention straps fastened to the cushions of the furniture article;

FIG. 2A is a top view of a protective cover in accordance with various embodiments;

FIG. 2B is a top view of a protective cover in accordance with various embodiments;

FIG. 3A is a bottom view of a protective cover in accordance with various embodiments;

FIG. 3B is a bottom view of a protective cover in accordance with various embodiments;

FIGS. 4A-F are bottom views of various protective covers illustrating connecting-material arrangements;

FIG. 4G is a detailed view of the quilting pattern of FIG. 4F taken within lines 4G-4G; and

FIG. 5 is a cross section schematic view taken along section line 5-5 shown in FIG. 2B.

### DETAILED DESCRIPTION

The subject matter of the disclosure herein may be described and implemented in various configurations and embodiments, and some particular embodiments may be described for purposes of explanation and illustration. It is to be understood, however, that other embodiments are within the scope of the invention.

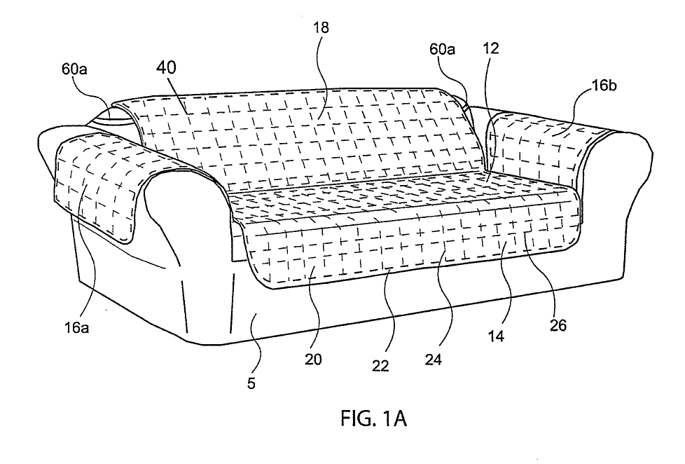

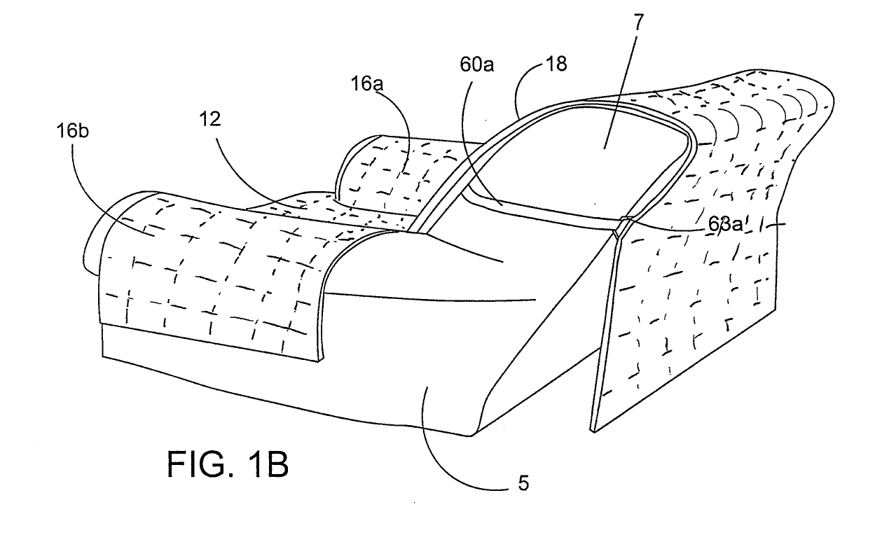

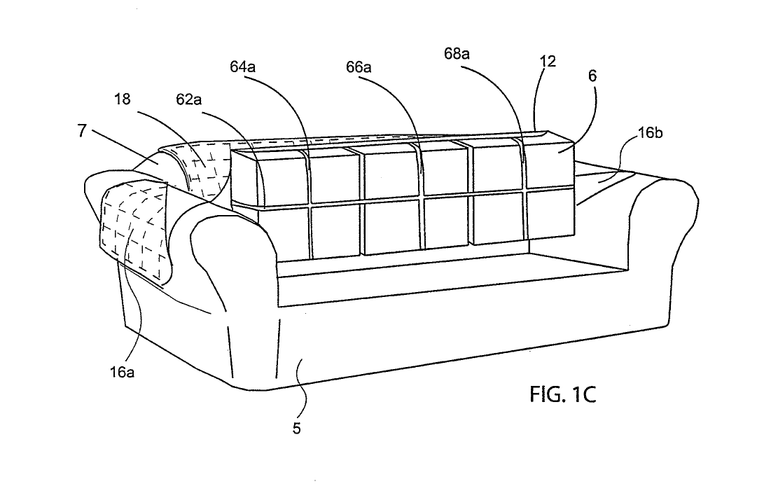

FIG. 1A illustrates a perspective view of a furniture article 5 with and embodiment of a protective cover 10 thereon in accordance with various embodiments. As shown, the protective cover 10 may be drapable over a furniture article 5 such that the frequently used areas of the furniture article 5 are covered by the protective cover 10, thereby reducing wear and tear on the furniture article. For example, the protective cover 10 may extend over one or more of the seat, leg area (as used herein the leg area also reference generally to any draped portion that could extend down from the main panel in the absence of other features like legs, arms, or a back on the furniture), arms, or back of the furniture article 5. Areas of coverage may also or instead be selected for changing their appearance or texture.

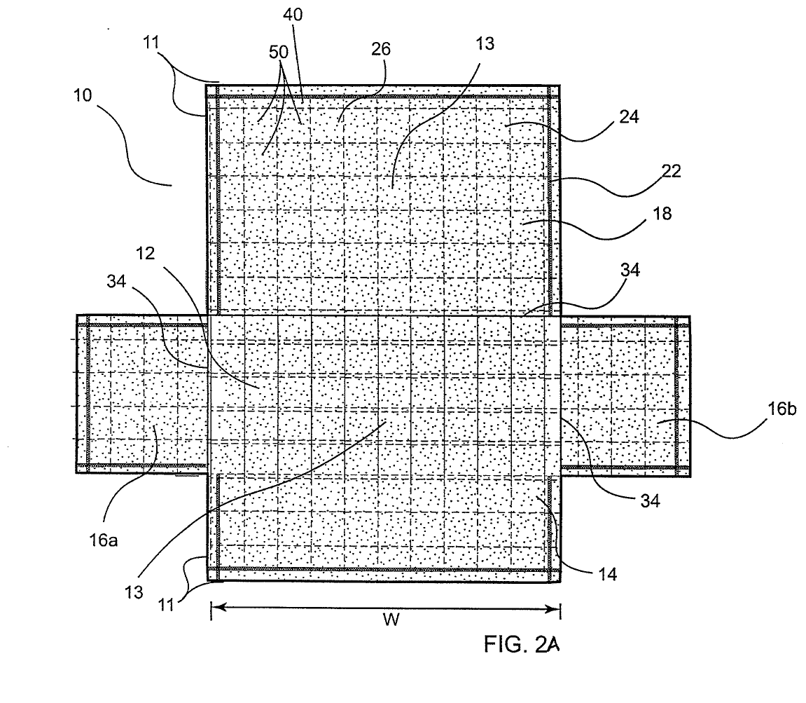

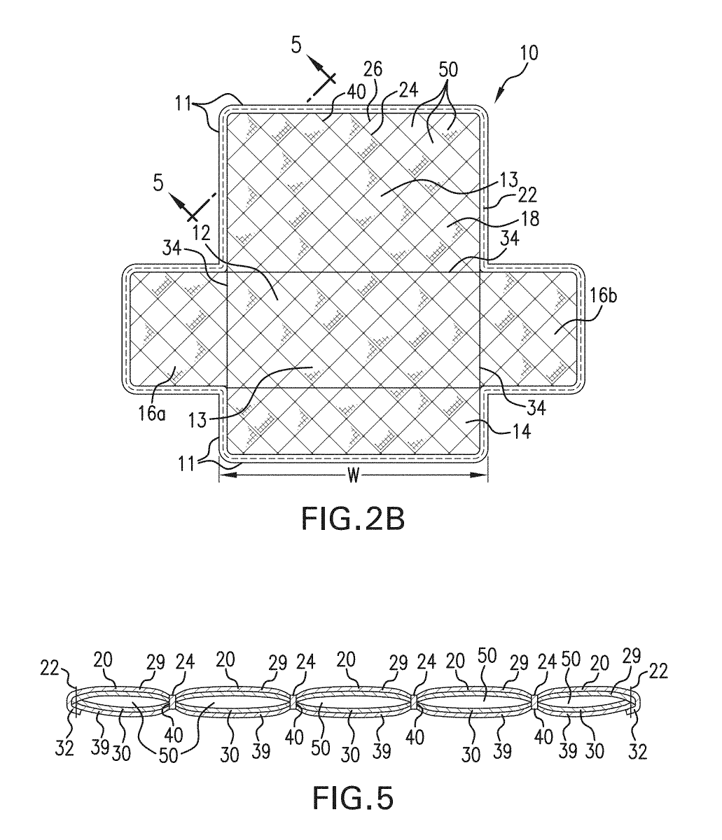

As shown in FIGS. 1A and 2, the protective cover 10 may have one or more panels to cover the various portions of the furniture article 5. For example, the protective cover 10 may have a seat panel 12 positioned to cover the seat portion of the furniture article 5. The protective cover 10 may have a back panel 18 positioned to cover the back portion of the furniture article 5. The protective cover 10 may have a leg panel 14 positioned to cover the lower portion of the furniture article 5 on which legs may contact and apply wear and tear. The protective cover 10 may have one or more arm panels 16a, 16b positioned to cover the arm portion of the furniture article 5.

Each panel of the protective cover 10 can be made of a separate panel sewn to one or more of the other panels or each panel can be a part of a larger fabric panel forming the main portion of the protective cover (e.g., the seat panel 12). As illustrated in the examples below, a single fabric panel of continuous weave can include two furniture portion panels, such as the seat and leg panels; or alternatively, these can be made of panels of continuous weave, connected together such as by sewing or other suitable method. Additionally, each furniture panel can be made of a single manufactured panel or of multiple, independently manufactured panels that are attached to each other.

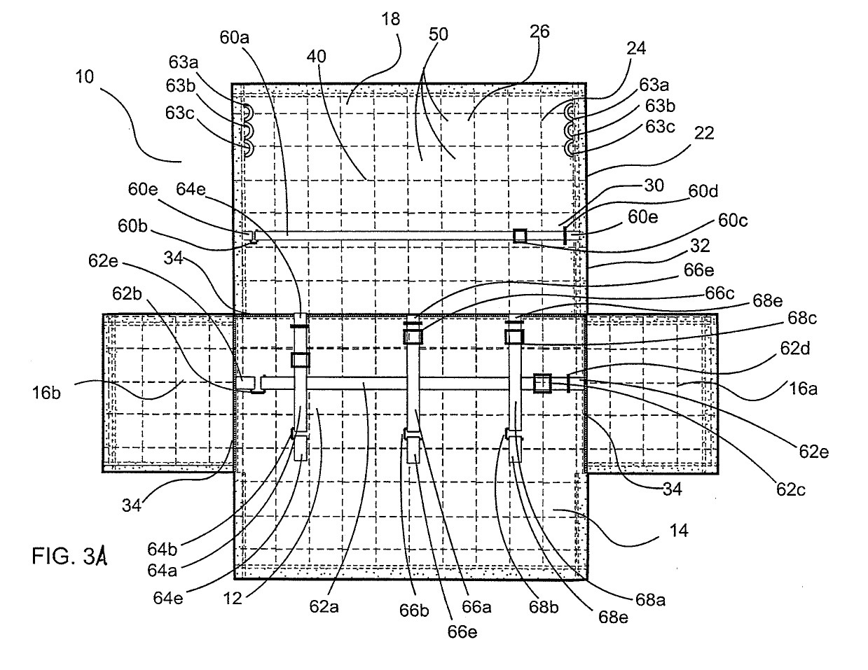

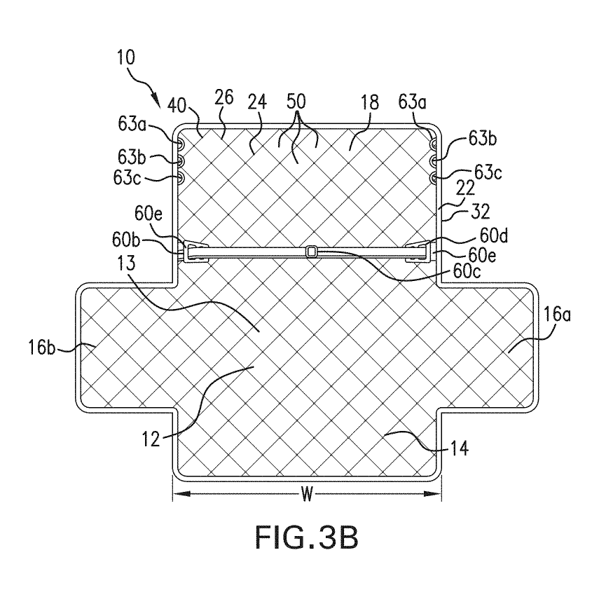

In accordance with various embodiments, and shown in FIGS. 2 and 3, the protective cover 10 may have a central panel. The central panel, depending on size or orientation, may be configured and operable as any of the above mentioned panels. In one example, the central panel may be the seat panel 12. One or more panels may extend from the central panel either laterally (e.g., arm to arm) or transversely (e.g., foot to back). For example, a back panel 18 may extend transversely from one edge of the seat panel 12. The one or more panels may be contiguous with the main panel or they may be attached separately. In one example, as shown in FIGS. 2A and 3A, the one or more panels are connected via a seam 34. In such examples, it is preferable that the seam is formed in such a way as to maintain a liquid resistant barrier. For example, the adjacent layers of material can be welded together or a sealing tape can be used across a seam that punctures the layer. In some examples, the seam may be sewn. In accordance with any of the various examples, the back panel 18 and the seat panel 12 may be connected along a connecting seam 34. In one example, a leg panel 14 may extend along one side of the seat panel. The leg panel may also be connected to the seat panel 12 along connecting seam 34 or may be a contiguous portion of the seat panel 12. In another example, arm panels 16a, 16b may extend laterally from the seat panel 12. These arm panels 16a and 16b may likewise be connected along a seam 34 on each lateral end of the seat portion. In a preferred embodiment, as illustrated in the examples of FIGS. 2B and 3B, one or more panels are contiguous with the main panel. The continuity between the extended panels and the main panels allows for one or more layers making up the cover 10 to be continuous throughout the entire cover area.

In various embodiments, one or more of the back panel 18, the leg panel 12, or the arm panels 16a, 16b may form a contiguous portion of the seat panel 12. In such embodiments, the cover may be sufficiently sized to extend over the back of furniture article 5, over the seat of furniture article 5 toward the floor, and/or laterally over the arms. Any one of the panels may extend any suitable length to provide a desired level of coverage of its corresponding furniture portion. For example, the seat panel or the main panel may extend about 80%, 90%, or 100% over the main area of the furniture (e.g., the seat of a chair or the table top of a table). Likewise the tertiary panels, e.g., the arm panels, the leg panels, or the back panels, if present, may extend between 10-100% over their respective areas of the furniture. For example, the leg panel 12 may extend to a desired length relative to the floor or down from the seat portion. For example, the leg panel may end approximately 8″ from the floor. Alternatively, the leg panel 12 may extend all the way to the floor. In various embodiments, the protective cover may be limited to extending over one or two elements of the future article such as the seat portion and armrest, the seat portion and the backrest, the seat portion and the leg portion, or any other combination of furniture article elements. In various embodiments, the protective cover may extend over three or more of the elements in any combination. In various embodiments, the protective cover may extend over all wear and tear surfaces of the furniture article such as the backrest, the armrests, and the seat. The protective cover may include a draped portion extending down from the main panel (e.g., the seat portion).

In the furniture industry, furniture articles are made in a variety of sizes. For example, common configurations include chair, loveseat, and sofa size furniture articles. The protective cover as disclosed herein, however, may be applicable to varied types of furniture of different sizes, including tables, counters, benches, or the like. However, as way of example, it may be noted that for typical furniture, the protective cover may typically have a transverse width of about 75 inches and a lateral width L (as shown in FIGS. 2A and 2B) of about 65 inches to 120 inches, with chair sizes being closer to the 65 inch side of the range and couches being closer to the 120 inch side of the range, with loveseats being between. However, the furniture may be any width.

Each protective cover 10 may have a peripheral region 11 (also referred to as the periphery 11) and an interior portion 13, surrounded by the peripheral region 11. The peripheral edge 11 may be that portion of the protective cover 10 that is proximal to the peripheral region. The interior portion 13 may be the portion of the protective cover 10 that lies within the peripheral edge 11. In one example, the peripheral edge 11 may be considered the portion of the protective cover 10 having a finished edge 32 wherein the protective material 20 is folded back on itself along the peripheral region. The interior portion 13 may be areas of the protective cover 10 central to this feature.

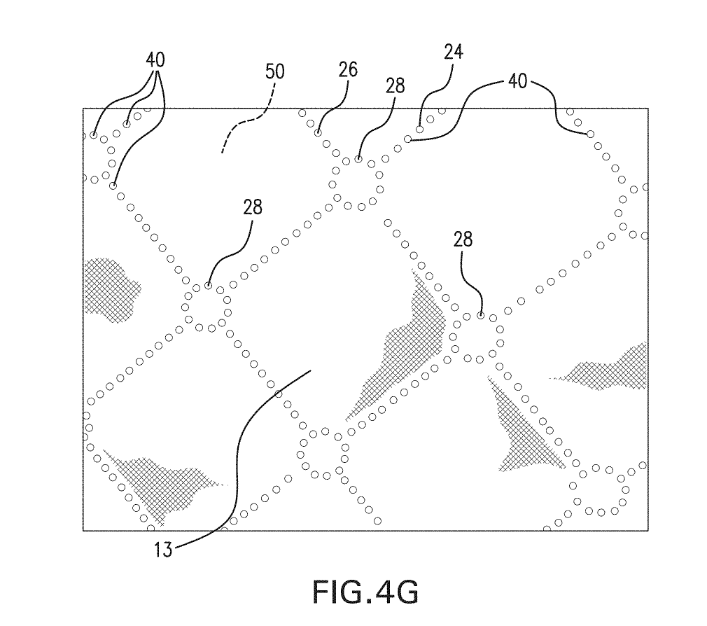

In accordance with various embodiments, the protective cover 10 may be configured such that liquid penetration between the top layer of the protective cover 10 and the bottom layer of the protective cover 10 is minimized. In this way the protective cover 10 can serve as a liquid protective cover for furniture articles. As shown in FIG. 5, depicting a cross section view of a protective cover 10, the protective cover 10 may include a protective layer 20 and a liquid barrier layer 30 of material. The protective layer 20 and the liquid barrier layer 30 may be connected to one another at their respective peripheries 11 and/or their interiors 13. Such connections are discussed in more detail below. Additionally, other layers of material may be included in addition to the protective layer 20 and the liquid barrier layer 30. For example, an intermediary layer 29 may be positioned between the liquid barrier layer 30 and the protective layer 20. Additionally or alternatively, a contact layer 39 may be positioned below the liquid barrier layer 30. This layer may contact the furniture article 5.

In accordance with various embodiments, the top layer 20 or the cover layer may be the layer in direct contact with the user of the protective cover 10. This top layer 20 may be a protective material that may be operable to reduce the wear and tear discussed above. This protective material may have characteristics that provide equal to or greater protection or wear resistance as compared to the furniture material itself. However, in some embodiments, the protective material may have relatively weak protective or wear resistance characteristics but may still serve as a sacrificial layer for the furniture. Regardless of the heightened or lowered protective qualities of the top layer it may be referred to herein as a protective layer. This protective material is also shown for example in FIGS. 1A, 2A and 2B. For example, the material may be made from a micro-suede product. Such a material may be knitted from 75D×T225D sea island filaments. Other materials may be used, however, such as natural materials (e.g., leathers, cottons, linens etc.) or synthetic materials (e.g., acetate, acrylic, nylon, polyester, rayon, etc.) These materials may be woven, knitted, non-woven, or a hybrid. For example, a natural material may be a polycotton blend or a synthetic material may be a polyrayon blend. Any hybrids or non-hybrids may be used.

Another layer 30 may be formed by a liquid barrier material. The liquid barrier material 30 may extend over a sufficient portion of the protective material 20 such that the movement of the protective cover 10 (over/across the surface of) the furniture article 5 is minimized. By increasing the coverage of the liquid barrier material 30 relative to the protective material 20, the protective cover 10 is able to provide greater protection from liquid spills to the furniture. In accordance with various embodiments, the liquid barrier material 30 may extend over more than ¼ of the protective material. In some embodiments, the liquid barrier material 30 may extend over more than half of the protective material 20. In some embodiments, the liquid barrier material 30 may extend over between 50% and 95% of the protective material 20. In various embodiments, the liquid barrier material 30 may be substantially co-extensive with the protective material 20.

The liquid barrier material 30 may have a suitably high resistance to liquids passing through the liquid barrier material. In one example, the liquid barrier is water proof. To achieve this or a similar desired liquid barrier affects, a variety of materials can be used. The liquid barrier material 30 may be made from any of a variety of polymers, fabrics (natural or synthetic), and composites of the two or other materials offering liquid barrier properties. For example, the liquid barrier may be formed via a polymer. In one example, the liquid barrier material 30 formed from a suitably thin a polyurethane sheet of material. A suitable thickness allows for minimal cost, while maintaining a drable feel. The thickness also is sufficient to limit tearing during the washing/drying process. In other examples, the liquid barrier material 30 may be a polyvinyl chloride (PVC), rubber, silicone elastomer, fluoropolymers, wax, or similarly suitable materials.

In accordance with various embodiments and as shown in FIG. 5, the protective layer 20 and the liquid barrier layer 30 can be separated by an intermediate layer 29. The intermediate layer 29 can be a fiber-fill material (e.g. cotton or poly-cotton fiberfill, or any suitable material such as those run through a garneting machine to make the material by the yard) or a gel or foam material. The material can provide additional support or weight to the protective cover. Additionally or alternatively, a contact layer 39 of material can be located below the barrier layer 30. The contact layer can be configured to contact the furniture article by separating the liquid barrier layer 30 from the furniture article 5. The contact layer 39 can be a non-woven backing (e.g. polyester or similar material or unwoven cotton and poly-cotton materials). The material can provide support to the intermediate layer or serve as an anti-slip layer to help maintain position of the protective cover. In some examples the fiber fill is non-absorbent functioning as a cushioning layer. In another example, the fiber fill is partially to fully absorbent. A partially absorbant layer absorbs minor spills limiting the liquid from running off of the furniture protector and onto an uncovered part of the sofa or the floor. A fully absorbent layer maximizes the aborbent proprets limiting or even preventing runoff of normal spills.

The cover 10 may be held in position on the furniture article 5 in a variety of manners. In one example, as illustrated in FIGS. 2A and 3A, one or more retention ties (e.g., 60a, 62a, 64a, 66a, or 68a) are connected to the cover 10 via at least one of the protective layer 20, the intermediate layer 29, the liquid barrier layer 30, or the contact layer 39. With regards to embodiments having the retention tie, preferably the retention ties are attached to the cover 10 in a manner that does not puncture the barrier layer 30. The attachment may be accomplished via adhesive, welding, laminating or a similar structure suitable to secure the retention ties to the cover without sacrificing or otherwise compromising the liquid barrier layer. In one example, the retention tie (e.g., 60a, 62a, 64a, 66a, or 68a) is positioned to extend around a portion of the furniture article 5. By extending around the portion of the furniture article 5, the retention tie (e.g., 60a, 62a, 64a, 66a, or 68a) anchors the cover 10 to the furniture article 5. The retention tie is attached to the cover 10 such that the liquid barrier material of the liquid barrier layer 30 or the contact layer 39 is held against the first portion of the furniture article.

When multiple retention ties are used, the different retention ties may secure the cover 10 at different locations or to different portions of the furniture article 5. As illustrated in the examples depicted in FIGS. 1B and 1C, the furniture article 5 includes various portions to which the cover 10 can be secured. For example, one portion may be one or more cushions 6, as shown in FIG. 1C. In another example, the portion may be the back support 7 of the furniture article 5 as shown in FIG. 1B. Other portions may include the arms, the seat, legs, or a base portion. The various retention ties may be positioned on the cover 10 in locations that allow the cover to be secured to the intended portions of furniture article 5.

In accordance with various embodiments, one or more retention ties (e.g., 64a, 66a, and 68a) may extend transversely across a portion of the central region, for example the seat panel 12. In embodiments having arm panels extending from the main panel 12 (e.g. as shown in FIGS. 2A and 3A), the retention ties (e.g., 64a, 66a, and 68a) are connected to the cover 10 without perforating or otherwise compromising the barrier layer. As indicated above, it is preferable to attach straps at the hems so that the barrier layer 30 is not compromised and the strength of stitching can be used, but in the alternative, when attached within the interior of the cover, the ends of the retention ties (e.g. 64e, 66e, and 68e) can be welded, adhered, or laminated to the cover 10. In such embodiments, the cover 10 may include the same number of transverse retention ties such that a separate retention tie is operable to extend around a separate seat cushion 6. In this way, each seat cushion 6 secures the cover 10 to the furniture article 5. One or more retention ties (e.g., retention tie 62a) extend laterally across a portion of the central region, for example, the seat panel 12. The retention tie 62a is of sufficient length to extend around a portion of the furniture article 5 such as a cushion. Alternatively, the retention tie 62a extends around successive portions such as multiple cushions 6 or all of the cushions 6 as shown in FIG. 1C. As shown in FIG. 3A, the plurality of retention ties (e.g., 62a, 64a, 66a, and 68a) may all be present together, such that various retention ties extend in different directions as compared to other retention ties located in the same region of the cover 10. As indicated some ties may extend transversely (e.g., ties 64a, 66a, and 68a) and some ties may extend laterally (e.g., tie 62a). In one example, the different ties extending in different directions are separate from one another and independently movable. In another example, the ties are connected to each other either permanently or detachably. The various retention ties may extend in other directions that provide improved engagement between the cover 10 and the furniture article 5.

In one example, the contact layer material may be solely relied on to limit relative movement between cover 10 and the furniture article 5. In another example, as illustrated in FIG. 3B, a single retention tie may be used (e.g., 60a). In a preferred embodiment, the retention tie, e.g. 60a, is secured at the hem 22. By securing the retention tie 60a at the hem, the retention tie 60a can be sewn into the hem without comprising the liquid barrier layer 30. For example, the retention tie 60a extends transversely across a portion of the furniture article such as the back rest 7. The retention tie 60a may extend around the back rest 7 such that the liquid barrier material is held against the back rest 7 of the furniture article 5. As the back panel 18 may be configured to extend over and drape back across the back rest 7, the retention tie 60a may extend transversely across the back panel 18 such that the retention tie 60a is operable to extend across the front of the back rest 7 pulling the cover 10 against the back of back rest 7 as shown in FIG. 1B. Other configurations of the back panel 18 and the retention tie 60a are also envisioned herein for example, the retention tie 60a may extend around the back of the back rest 7 pulling the cover 10 against the front of the back rest 7. Alternatively, two different portions of the back panel 18 may be connected on the transverse sides of the back panel 18 such that the back panel 18 forms a pocket that can be pulled down and over the back rest 7. The retention ties may be utilized to extend around multiple portions of the furniture article.

In accordance with another embodiment, the retention loops 63a-c may be additionally or alternatively positioned on the back panel 18. For example, either a single loop engages the retention tie 60a or a pair of loops engages the retention tie 60a, such as loops 63a, loops 63b, or loops 63c. While FIGS. 3A and 3B are shown with three loop pairs 63a, 63b, and 63c, this is merely by way of example. In other examples, a single loop is used. Alternatively, in another example, a single loop pair is used. In yet another embodiment, a plurality of loops or loop pairs is used. The loops 63a-c can be utilized to increase the friction between the back panel 18 and the back rest 7 on both the front of the back rest 7 and on the back of the back rest 7. In one example, the retention tie 60a is attached to the back panel via attachments 60e on the lateral sides of the pack panel 18. The retention loops are located a transverse distance from the retention tie 60a. As shown in FIGS. 3A and 3B, the loops can be located at the lateral sides of the back panel 18. In other embodiments, the loops are additionally or alternatively located at various locations along the interior space of the back panel. The transverse distance is a distance that allows the retention tie 60a and the retention loops 63a-c to be located respectively along the transverse distance of the back panel 18 such that when the back panel 18 is laid over a back rest 7, the retention tie 60a and the retention loops 63a-c are located on opposite sides of the back rest from one another. In this position, the retention tie 60a is able to pass thorough one or more of the loops 63a-c as the retention tie 60a extends around the back rest 7. By engaging the retention tie 60a with the loops 63a-c, the retention loops are able to bias the back panel 18 toward the back rest 7. In this way, the connection between the retention tie 60a and the back panel 18 biases the back panel 18 to the back rest 7 on a first side when the retention tie 60a is extended around the back rest 7 and the retention loops 63a-c variously anchor the back panel 18 to the retention tie 60a on a second side of the back rest 7. By biasing the back rest on each of the two sides of the back rest 7, friction between the back rest 7 and the back panel 18 is increased.

In accordance with various embodiments, the back panel 18 may include multiple pairs of retention loops (e.g. 63a-c). Each of the multiple pairs of retention loops may be positioned at different traverse locations on the back panel 18. By locating these retention loops at different locations, the back panel 18 is adaptable to different furniture having different heights of back rests. For example, a low back rest 7 can utilize retention loops 63c, a medium height back rest 7 can utilize retention loops 63b, and a tall back rest can utilize retention loops 63a.

FIG. 3A illustrates the retention tie 60a being closer to the seat panel 12 than the retention loops 63a-c. However, in other embodiments, the retention loops 63a-c may be located closer to the seat panel 12 than the retention tie 60a. In this embodiment, the retention tie 60a may extend forward from the back panel 18 around the front of the back rest 7 and through the retention loops, which are located in such and embodiment proximal to the front of the back rest 7. The retention loops 63a-c are connected to any one of the various panels on the cover. In one example, the connection may be a fixed connection via a sewn stitch, staple, adhesive or other similar fixed connections located at a seam or across the interior surface of a panel. In another example, the connection may be a removable connection via a fastener such as a button, snap, hook and loop, a tie or other similar removably attached connections. The retention loops 63a-c can be formed from a variety of materials including fabric or non-woven straps, string, elastic or similar type structures. Additionally or alternatively, the retention loops 63a-c can be hardware such as rings, wires, ties, or other suitable hardware.

While the various embodiments of the retention loops 63a-c are discussed herein with respect to the loops being positioned to be utilized with a furniture back rest 7, it should be appreciated that the loops may be positioned on or relative to any other panel to allow for other retention straps to engage the loops and secure the cover to both sides of other furniture portions. For example, loops could be located on the leg panel 14 and engage with the retention strap 62a by folding the leg panel 14 under the seat cushions. Additionally or alternatively, a panel extending from between the back panel 18 and the seat panel 12 could tuck under the seat cushions and this panel would also benefit from the retention loops being located thereon. However, such a panel would preferably be attached and the retention loops associated therewith would preferably be attached in a way that did not compromise the liquid barrier layer 30.

In accordance with various embodiments, the retention tie is formed of a material in a shape or form operable to connect, attach or secure the cover 10 to a portion of the furniture article 5. In some examples, the retention tie is a flexible material such as an elastic material. An elastic material can automatically tighten from an elongated length to a shorter on. As such, as long as the portion of the furniture article 5 enclosed in the elastic material has a size between the minimum and maximum lengths of the elastic material then the elasticity will collapse the length of the tie to secure it to the furniture article 5. Alternatively, the retention tie is an inelastic having features to tighten the retention tie as opposed to relying on its change in length due to flexibility. The retention tie may include combinations of materials and properties. The retention tie may be a thread, string, cable, strap, band, or other suitable structure operable to secure the cover 10. For example, the retention tie may be a strap that forms an aesthetically pleasing appearance with the furniture article.

In one example, the retention tie is connected to the cover at a seam between panels. However, if connected to a seam it is preferable that the seam is treated such that it forms a continual liquid barrier and the retention tie is connected in such a way as to not compromise that liquid barrier. In another example, the retention tie is connected to the panel surface.

In accordance with various embodiments, a portion of the retention tie is removable by hand from the cover. In this way, the retention tie may be formed of multiple parts. For example, the retention tie may include fastener (e.g., 60b, 62b, 64b, 66b, and 68b) suitable to disengage and reengage the retention tie with the cover 10. Examples of fasteners may include hook and loop type fasteners (e.g., Velcro), hardware style fasteners (e.g., buttons, snaps, zippers, buckles etc.). In one specific example, one portion of the tie may include a male engagement such as a plastic hook with an opposing portion of the tie forming a female engagement such as a loop on the end of the tie portion. In various embodiments, each end of the retention tie includes a fastener such that a middle portion of the retention tie is fully detachable from the cover via the removable fastener such that the retention tie may be removed. As shown in FIG. 3A, one end of the retention tie 62a includes a fastener 62b and the other end includes fastener 62d. The two fasteners may be the same type or they may be different types. In embodiments, having a plurality of retention ties, some or all of the ties may also be detachable have fasteners on each end.

In embodiments, with retention ties being multiple parts, the fasteners (e.g., 60b, 62b, 64b, 66b, and 68b) are attached to the removable portion of the retention tie (e.g. 60a, 62a, 64a, 66a, and 68a). The removable portions of the retention tie are connected to a fixed portion of the retention tie (e.g. 60e, 62e, 64e, 66e, and 68e). In some embodiments, the fixed portion of the retention tie is formed of the same material as the removable portions of the retention tie. In other embodiments, the fixed portion of the retention tie is a different material, such as a hardware portion that is attached to the panel portions of the cover. In one example, the fixed portion (e.g. 60e, 62e, 64e, 66e, and 68e) is a short elastic loop operable to receive hardware such as a hook attached to the retention tie (e.g. 60a, 62a, 64a, 66a, and 68a).

In accordance with various embodiments, the retention ties (e.g., 60a, 62a, 64a, 66a, or 68a) are adjustable in length. As indicated above, the retention ties may be flexible such that the retention ties are adjustable in length due to their flexible nature. Additionally or alternatively, the retention ties may include length adjusting hardware or structure. For example, each retention tie may include a buckle (e.g., 60c, 62c, 64c, 66c, or 68c) operable to allow changes in the length of the retention tie. In another example, the retention tie may have a hook and loop surface with a return loop allowing the tie to double back on itself and adjusting its length by engaging the hook surface with the loop surface (e.g., Velcro.)

In accordance with various embodiments, as shown in FIGS. 1A-3B, the movement between the liquid barrier material 30 and the protective material 20 may be minimized or negated by including attachment locations between the liquid barrier material 30 and the protective material 20. These attachments may also include additional layers such as the intermediate layer 29 and the contact layer 39. The attachment locations 40 may be formed by any suitable device, method or material that connects the protective layer 20 and the liquid barrier layer 30. In various embodiments, the attachment locations may be formed by direct attachment of the two layers. In order to maintain the integrity and functionality of the liquid barrier layer 30, it is preferable that the attachments are made without puncturing the liquid barrier layer 30 at least on the internal portion of the cover 10. The direct attachment may be made by fusing one layer to the other. For example, each of the layers in the cover 10 can be made entirely of or partly of an elastomer that could be adhered or melted to one another. By heating (or by another manner) the layers and fusing them together the attachment locations are formed with a connecting material 40 being defined by the fusion of materials. In one example, each of the layers forming cover 10 (e.g. protective layer 20, intermediate layer 29, and barrier layer 30) may be connected with all of the layers fused such that the material of each layer forms the fuse, or in another example, the intermediate layer 29 may be sufficiently porous such that the protective layer and the barrier layer are fused to one another through the intermediate layer without, the material of the intermediate layer 29 actually forming a part of the fuse.

In one example the fused connecting material 40 may be formed by using high frequency sound waves plus rollers which put pressure between the two fabrics together. An example of this type of connection is accomplished by pinsonic quilting. In another example, the fused connection material 40 may be formed by applying heat to the stacked layers of material. In another example, the layers may be connected by an adhesive or other suitable mechanism that maintains the general characteristics of the water barrier or protective cover.

In another example, the connecting material 40 may be an adhesive that binds the protective layer to the liquid barrier layer. Adhesives may include traditional fabric glues, two sided tape, or strips of adhesive (as opposed to allover fabric coverage). In various embodiments, a laminate may be used. The laminate, however, may glue significant portions of the two fabrics together. Other adhesive method might include applying heat to the two fabrics so that they fuse. Another adhesive method may include hook and loop fasteners (e.g., Velcro).

In some embodiments, some of the layers may be connected to one another in one way while other layers are connected to one another in a second way. For example, the protective layer 20 and the intermediate layer 29 may be laminated to one another. The layers may be laminated in such a way that substantially all points of contact between the layers form a fixed connection. Additionally or alternatively, the liquid barrier layer 30 and the contact layer 39 may be laminated to one another. Again, the layers may be laminated in such a way that substantially all points of contact between the layers form a fixed connection. In some embodiments, the laminated protective layer and the laminated liquid barrier layer may then be fused to one another along the discreet locations via the fused quilting discussed above. By laminating the top two layers and then the bottom two layers, the effects of the fused quilting are improved because absent the laminated layers, there is a significant chance that all of the layers would not fuse together at all locations. Additionally, it is difficult to get more than two layers through a pinsonic process at the same time in the proper alignment. In some embodiments, all four layers could be laminated together. The, however, would create a stiff or plastic feel to the cover. Thus the combination of lamination and fusing provides a more flexible feel to the material.

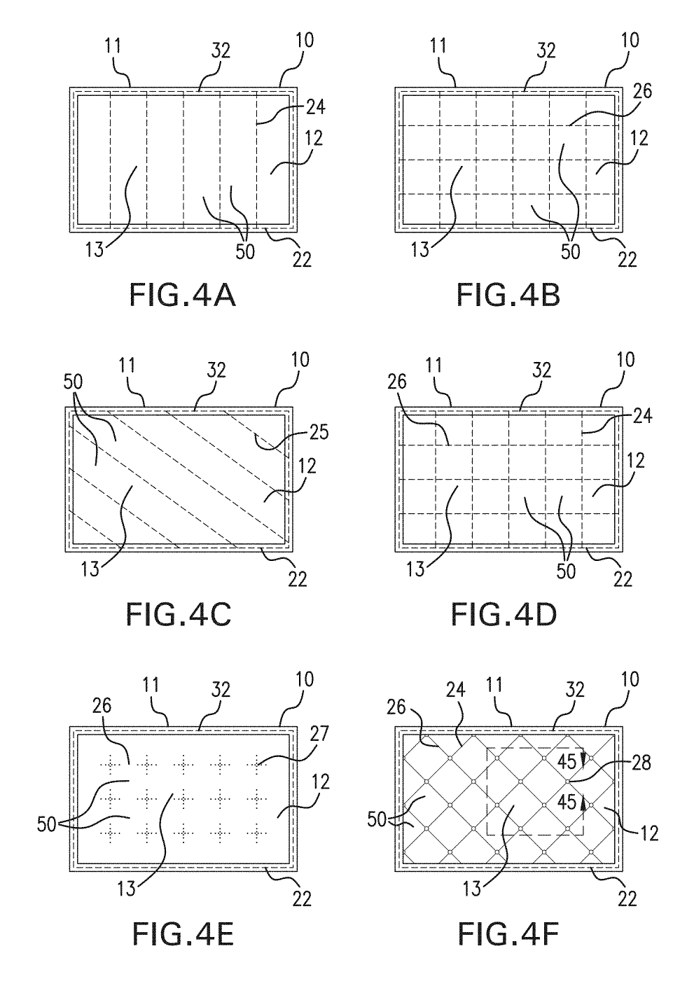

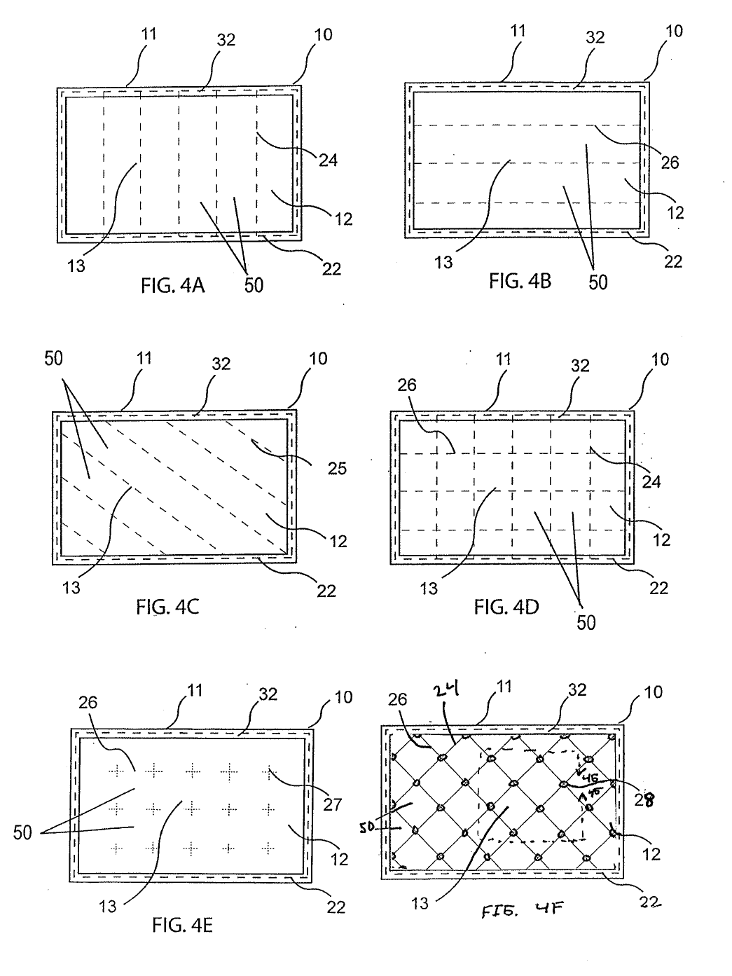

In various embodiments, the attachment locations (e.g., connecting material 22, 24, 25, 26, 27, and 28 as shown in FIGS. 4A-4 G) are spaced from one another. The positioning of the attachment locations with the spacing may be arranged across one or more directions of the material. An example of an arrangement in two directions would be a quilting pattern of attachments locations connecting liquid barrier layer and the protective layer. In this way an attachment may extend from edge to edge of the cover or only a partial distance across the cover connecting the layers with a parallel attachment spaced apart from the first attachment with an unattached portion 50 extending between the two attached portions. In a different direction a similar arrangement may occur, with an angled attachment extending all the way or part way across the cover connecting the layers. This angled attachment being positioned at an angle to the first attachment. The angled attachment may also have a parallel attachment extending across or part way across the cover immediately adjacent two it. Each of the parallel attachments may have a space therebetween with the materials not being attached. The intervals of attached layers and unattached layers may provide a sufficiently discontinuous arrangement on the cover, such that it does not significantly modify the flexibility or rigidity of the protective cover 10. Each of the unattached portions 50 may be of sufficient size such that the flexibility of the cover 10 is not significantly modified. For example, in a quilted arrangement the unattached areas may be defined on each side by attached locations. In any of the various embodiments, parallel attached locations may define some portion of the unattached area between the layers. In various examples, the unattached portion 50 may be between ⅕ the lateral distance W or transverse length T of the cover and 1/30 of the lateral length W or transverse length T of the cover. In various embodiments, the unattached locations may extend between 2-10 inches in the lateral length and between 2-10 inches in the transverse length.

The embodiments of the quilting shown in FIGS. 1-3 are merely examples of quilting patterns that can be used. Any of the embodiments discussed with regard to FIGS. 4A-4G are applicable to the covers shown in FIGS. 1-3 and the various aspects discussed with regards to those covers may be used with the aspects of the covers described with regard to Figs. FIGS. 4A-4G.

The connecting material may be discontinuous in one or more of two dimensional directions of the layers. The connecting material may, for example, be continuous in a lateral direction at various intervals but be discontinuous in the transverse direction as shown in FIG. 4B. Or, the connecting material may, for example, be continuous in a transverse direction at various intervals but be discontinuous in the lateral direction as shown in FIG. 4A. A combination of these two patterns may form a quilting pattern as shown in FIG. 4D. In this way the connecting material may form attached and unattached portions of the two layers at intervals across the cover in multiple directions. Each interval of unattached materials may be of other suitable sizes. The unattached portions may be increased in size by having the intervals between connecting materials increased. Conversely, the unattached portions may be decreased in size by having the intervals between the connecting materials decreased. By having the intervals of attached portions and unattached portions the flexibility is improved over the liquid barrier layer continuously attached to the protective layer such as in laminating or gluing of the liquid barrier layer to the protective layer.

For example, separate discrete dollops of adhesive (see connections 27, e.g., FIG. 4E) may be used to form separate discrete connection points between the protective layer 20 and the liquid barrier layer 30. In another embodiment, separate discrete stitches may connect the protective layer 20 and the liquid barrier layer 30. In another example, the connection between the protective layer 20 and the liquid barrier layer 30 may be continuous for at least a short distance. The length of the continuous connection point may be minimized for an adhesive as it may affect the flexibility or the rigidity of the protective cover 10. In some embodiments the stitching material may extend across only a portion or across a few different portions of the cover 10. In other embodiments, the stitching material may extend all the way across or around the protective cover 10.

A combination of the patterns of FIGS. 4A and 4B that is rotated at a 45° angle may form a quilting pattern as shown in FIG. 4D. This pattern also utilizes discrete fusing locations along the material (see connections 26, 24, 28, e.g., FIG. 4E) to form separate discrete connection points between the protective layer 20, the intermediate layer 29, the liquid barrier layer 30, and/or the contact layer 39. In another example, the connection between the protective layer 20 and the liquid barrier layer 30 may be continuous for at least a short distance. The length of the continuous connection point may be minimized for an adhesive as it may affect the flexibility or the rigidity of the protective cover 10. FIG. 4G illustrates a detailed view of the quilting pattern using the fused connections 40. In this example, circles 28 formed by discreet fusing locations are present at the intersections of lines of discrete fusing locations 26 and 24.

In accordance with various embodiments, as shown in FIGS. 1-4, the connecting material may form a connected periphery 22 between the protective layer 20 and the liquid barrier layer 30. In accordance with various embodiments, the connecting material may also be located at the interior of the protective layer 20 and the liquid barrier layer 30 forming an interior connection (e.g., 24, 25, 26, and 27 of FIGS. 4A-E) between the two layers. By connecting the two layers at their respective interiors, movement between the two layers is minimized, negating need to increase the coefficient of friction between the two materials. Regardless of the locations of the connection material 40, it may be placed discretely or continuously. For example, the protective layer 20 and the liquid barrier layer 30 may be connected by the connecting material 40 around the periphery with either discrete connection points or continuous expanse of connection material. Similarly, the protective layer 20 and the liquid barrier layer 30 may be connected with either discrete connection points or a continuous expanse of connection material across the interior of the protective cover 10.

FIGS. 4A-E are various bottom views of protective covers illustrating various connecting material arrangements in accordance with various embodiments. In various examples, the protective layer and the liquid barrier layer may be quilted together, with connection material extending in multiple directions across the cover 10. FIGS. 1, 2, 3 and 4D illustrate this configuration. FIG. 4A illustrates another example with connection material 24 extending transversely across the cover 10, with each portion of connection material extending in the same directions. In still another example, the connection material 26 may extend in a lateral direction as shown in FIG. 4B. In yet another example, the connection material 25 may include both a transverse component and a lateral component as shown in FIG. 4C. In another example, the protective layer and the liquid barrier layer may be connected with large but discrete connections 27 as shown in FIG. 4E. Alternatively, or additionally, the protective layer and the liquid barrier layer may be connected with small discrete connections such as spot welds, such as those shown in FIG. 4G. As shown in each of these particular examples, the protective cover is formed from the protective layer and the liquid barrier layer, which are connected at both their periphery and their interior. As discussed herein, the protective layer and the liquid barrier layer may be fused or otherwise connected directly to one another (e.g. through a porous intermediary layer or absent any intermediary layer) or they may be fused or otherwise connected to one another via fusing with an intermediary layer there between. In various examples, such a fuse may include the material of each layer or in other examples this fuse may only include the material of the layers that are immediately adjacent to one another. The quilting is caused by for example ultrasonic fusing. The patters caused by the ultrasonic fusing form the quilting which can provided an artistic expression on the material.

As illustrated in FIG. 5, which is a schematic cross section of a protective cover such as that shown in FIG. 2B across cross section line 5-5, a protective cover 10 may include the plurality of attachment locations 40. These attachment locations may be mere contact points between the layers (e.g., such as when to materials are sewn together) or the attachment locations may be fixed attachments such as welding or adhesive. As shown in this example, a connective thread 24 may extend between the two layers 20, 30 to attach them. Unattached portions 50 may be located between the attachment points. The layers are shown with no contact along this unattached region 50 in FIG. 5, this is to illustrate their unattached nature allowing them to move freely from one another. However, the layers may maintain full contact along these regions as well. The periphery of the cover 10 may have a finished edge 32 having an attachment shown by the connecting thread 22.

In accordance with various embodiments, the stitched connection material may be sewn into the protective layer 20 and the liquid barrier layer 30. Traditional furniture fabric stitching machines have been found by the inventor to be unable to handle the 200 cm width fabrics. Also, quilting the protective cover 10 increases the stress on sewing needles significantly. When using insufficiently capable needles, the needles would overheat and break going through both the liquid barrier material and the protective layer. Traditional quilting machines proved insufficient at handling the stress on the needle. The use of traditional quilting machines, e.g., multi-needle sewing machines, caused excessive needle breakage in sewing through PVC-coated mesh fabric that is layered with a protective cover. As such, sewing through 2 layers of the anti-skid material and 2 layers of the protective material (see, e.g., seams 22) proved too much for quilting-style sewing machines. To overcome the deficiencies of traditional quilting machines, a wide multi-needle quilting machine with larger needles may be used to attach the protective layer to the liquid barrier layer (e.g., the protective fabric to the liquid barrier backing). Also, a side hem or binding may be sewn around the periphery connection 22 on the protective cover without experiencing significant broken needles. For example, sewing machines for industrial carpet-manufacture may be used to stitch the protective layer to the liquid barrier layer, particularly at the periphery connection 22. The carpet-style sewing machine is also sufficient to handle the 200 cm width fabrics used to form the protective cover 10.

In accordance with another embodiment, the protective covering is a single seamless structure. Each of the layers of material making up the protective covering, as discussed in the various examples and embodiments provided herein, are also single seamless sheets. The continuous pieces are then fused together to form the continuous protective covering 10.

In accordance with various other embodiments, the protective layer and the liquid barrier layer may be laminated together, but his often causes a significant stiffening of the protective cover in its multi-layer regions. In such an embodiment extensive adhesives, temperatures, and/or pressures may be used to laminate the protective layer to the liquid barrier layer. In various embodiments, the liquid barrier material may be printed directly to the protective material in the form of discrete dots. In various embodiments, the liquid barrier material may be attached by a hook and loop fastener system to the protective material. In various embodiments, the protective material may be impregnated or embossed with liquid barrier materials.

Having described several embodiments herein, it will be recognized by those skilled in the art that various modifications, alternative constructions, and equivalents may be used. The various examples and embodiments may be employed separately or they may be mixed and matched in combination to form any iteration of the alternatives. Additionally, a number of well-known processes and elements have not been described in order to avoid unnecessarily obscuring the present invention. Accordingly, the above description should not be taken as not limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A liquid barrier furniture protective cover, comprising:
a first layer formed of a protective material having a peripheral region surrounding an interior portion;
a second layer formed of an liquid barrier material having a peripheral region surrounding an interior portion; and
a third layer attached to at least one of the first layer or the second layer, wherein at least two of the first layer, the second layer, or the third layer are fused together at a plurality of locations defining a quilted connection.

2. The liquid barrier furniture protective cover of claim 1, further comprising a fourth layer that is fused to at least one of the first layer, second layer, or third layer.

3. The liquid barrier furniture protective cover of claim 1, the second layer is a polyurethane material.

4. The liquid barrier furniture protective cover of claim 1, wherein the second layer is a fiber-fill material.

5. The liquid barrier furniture protective cover of claim 1, wherein the fourth layer is a non-woven backing material.

6. The liquid barrier furniture protective cover of claim 1, wherein the second layer is laminated to the fourth layer, and the first layer is laminated to the third layer.

7. The liquid barrier furniture protective cover of claim 6, wherein each of the plurality of fused locations are spaced from one another such that the first layer and the second layer are unattached to each other between the plurality of fused locations.

8. The liquid barrier furniture protective cover of claim 2, wherein at least some of the plurality of fused locations are spot welds that are arranged in patterns that form a plurality of line patterns that in turn form a quilted pattern.

9. The liquid barrier furniture protective cover of claim 3, wherein the quilted pattern is arranged in intervals extending across a portion of the interior portion of the liquid barrier material and the protective material.

10. The liquid barrier furniture protective cover of claim 3, wherein the quilted pattern traverses the interior portion from a first portion of the peripheral region to a second portion of the peripheral region.

11. The liquid barrier furniture protective cover of claim 3, wherein the quilted pattern traverses the interior portion having the plurality of lines extending in two different directions.

12. The liquid barrier furniture protective cover of claim 1, wherein the protective material comprises a plurality of different panels extending from a central region sized to extend over a seat portion, a back portion, and arm portions of a chair or couch.

13. The liquid barrier furniture protective cover of claim 1, wherein liquid barrier material extends substantially co-extensive with the protective material.

14. The liquid barrier furniture protective cover of claim 1, wherein the first layer is folded back on itself over the second layer prior to fusing the two layers together proximal to the peripheral region.

15. A method of manufacturing the liquid barrier furniture protective cover comprising: forming a plurality of fused locations thereby connecting a protective layer, an intermediate layer, and a liquid barrier layer by applying high frequency sound waves between the protective layer, the intermediate layer, and the liquid barrier layer.

16. The method of claim 15 further, comprising applying pressure between the protective layer, the intermediate layer, and the liquid barrier layer during the application of the high frequency sound waves.

17. The method of claim 16, wherein the pressure is applied between the protective layer, the intermediate layer, and the liquid barrier layer via opposing rollers.

18. The method of claim 17, wherein heat is also applied between the protective layer, the intermediate layer, and the liquid barrier layer via opposing rollers.

19. The method of claim 18, wherein the fused locations are located at interior portions of the protective layer, the intermediate layer, and the liquid barrier layer.

20. The method of claim 16, wherein interior portions of the first layer, the second layer, and the third layer may be connected without puncturing any of the layers.
